(19) United States
(12) Patent Application Publication
(10) Pub. No.: US 2007/0040314 A1
(43) Pub. Date: Feb. 22, 2007

(54) Adjustable tool holder

(75) Inventors: Thomas Seow Keat Woo, Penang (MY); Ching Tai Tan, Penang (MY)

Correspondence Address: HAMRE, SCHUMANN, MUELLER & LARSON, P.C., P.O. BOX 2902, MINNEAPOLIS, MN, 55402-0902, US

(73) Assignee: LKT AUTOMATION SDN BHD, Penang (MY)

(21) Appl. No.: 11/484,897

(22) Filed: Jul. 12, 2006

(30) Foreign Application Priority Data
Jul. 12, 2005 (MY) PI 20053178

(51) Int. Cl. B23Q 1/25

(52) U.S. Cl. 269/73

(57) ABSTRACT

The adjustable tool holder comprising a base plate has a top surface with a longitudinal groove thereon. An intermediate plate has a bottom surface ribbed at the center to be fitted into the longitudinal groove, and a top surface with two transverse grooves at the opposing ends of the top surface. A block piece is mounted between the transverse grooves and an elongated rod is extended across one of the transverse groove with its inner end connected with a roller. A top plate has its bottom surface formed with a recess for receiving the block piece and it is formed with an inclined surface for enabling the elongated rod to engage with the roller and to move the top plate in transverse directions. An operating rod is extended from the outer end of the base plate is used for adjusting the longitudinal movements of the top plate.

### FIELD OF INVENTION

The present invention relates to an improved tool holder for firmly and accurately positioning a tool, more particularly the tool may be adjusted with extreme precision along x, y axes relative to the holder.

### BACKGROUND OF THE INVENTION

A variety of tool holders and X-Y tables are available and known to the prior art. However, most of these holders are used in the semiconductor industries.

In the semiconductor industries accuracy and precision are important criteria to observe. For example in a pick and place mechanism, it is crucial that when an arm or a pick up nozzle lifts an integrated circuit (IC) from point A to point B, the said IC should be place at the correct position failing which would unable the arm to pick the IC. Similarly in the marking testing or inspection processors it is necessary again for the IC to be placed at the correct position.

Typically, to ensure the accuracy of the placement of the ICs placed on a machine or table, measurements are taken to make sure that the machine or table are placed at the intended spot and mounted thereafter. However after some time there is a tendency that the machine would move away from the calibrated spot due to several factors such as accidental push or vibrations from related devices.

When the machine or table is moved, it has to be remounted again which may be seen as a cumbersome or time consuming act.

Therefore, there is a need to have a tool holder to be used in the semiconductor industry that provides X-Y direction movement.

### SUMMARY OF THE INVENTION

The present invention relates to an adjustable tool holder for holding a work module whereby a module held thereby may be adjusted along mutually perpendicular axes. The adjustable tool holder comprising a base plate having a top and bottom surfaces, whereby the bottom surface is to be placed on a base and the top surface having a longitudinal groove thereon. An intermediate plate is attached to the base plate. The intermediate plate has a bottom surface ribbed at the center to be fitted into the longitudinal groove of the base plate, and a top surface having two transverse grooves at the opposing ends of the top surface. A block piece is mounted between the transverse grooves. An elongated rod extended across one of the transverse groove of the intermediate plate with its inner end connected with a roller which is placed adjacent the block piece. A top plate is mounted to the intermediate plate of the adjustable tool holder. The top plate having its bottom surface formed with a recess for receiving the block piece and the recess is formed with an inclined surface for enabling the elongated rod to engage with the roller and to move the block piece in transverse directions within the recess.

The base plate is attached with a base attachment attached at the side of the base plate. An operating rod which is extended from the outer end of the base attachment into the base plate is used for adjusting the longitudinal movements of the top plate.

### BRIEF DESCRIPTION OF THE DRAWINGS

FIG. 1 illustrates the adjustable tool holder according to the present invention when fully assembled.

FIG. 2 shows an exploded view of the adjustable tool holder of the present invention from the top.

FIG. 3 shows an exploded view of the adjustable tool holder of the present invention from the bottom.

FIG. 4 shows the detailed of the base plate with the intermediate plate of the adjustable tool holder.

FIG. 5 illustrates the detailed of the base plate of the adjustable tool holder.

### DETAILED DESCRIPTION OF THE INVENTION

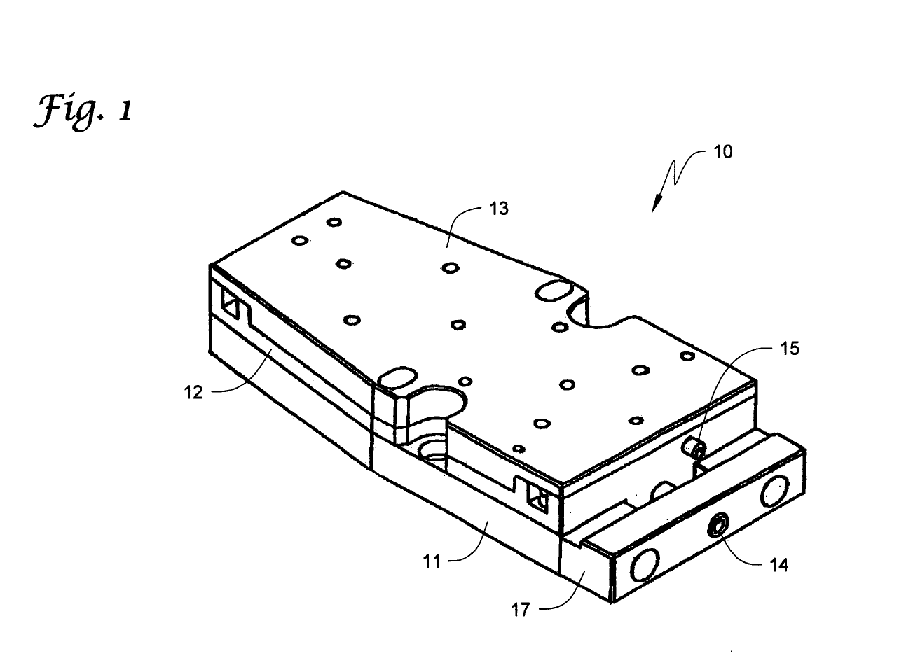

As shown in FIGS. 1, the invention is in assembled condition. An adjustable tool holder (10) of the present invention is comprised of three plates, namely a base plate (11), an intermediate plate (12) and a top plate (13) which are mounted together and two rods (14, 15) extended from the side of the base plate (11) and intermediate plate (12) respectively. The rods (14, 15) are to provide the transverse or longitudinal movements to the top plate (13) where a work module is mounted onto.

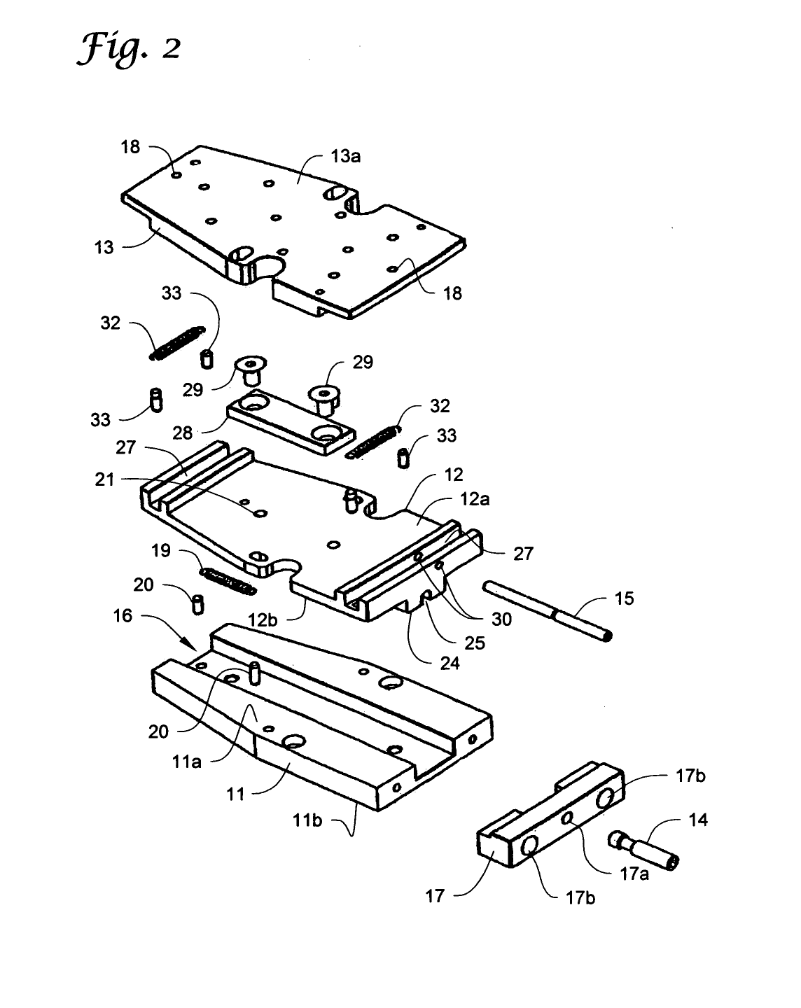

The base plate (11) of the adjustable tool holder (10) is typically placed on a base such as fixed to a table. The base plate (11) has a bottom surface (11b) to be placed on the base and a top surface (11a) having a longitudinal groove (16) thereon as shown in FIG. 2. The bottom surface (11b) of the base plate (11) is preferably a flat surface. The longitudinal groove (16) is formed in the lengthwise for the base plate (11). A base attachment (17) having a threaded hole (17a) at substantially middle and extended from the side of the base attachment (17) for receiving an operating rod (14) and a pair of through holes (17b) to be fastened to a first end of the base plate (11) by fasteners. A biasing means (19) is fitted in longitudinal direction within the longitudinal groove (16) at the other second end opposing the first end where the base attachment (17) is attached. The biasing means (19) is held by two posts (20) vertically mounted at the longitudinal groove (16) of the base plate (11) as shown in FIG. 5. One of the posts is extended into an aligned hole (21) provided at the intermediate plate (12). The longitudinal movements of the tool holder (10) in Y direction are adjustable by adjusting the operating rod (14). The operating rod (14) is preferably a threaded operating rod to enable a more precise movement of the operating rod (14) into the threaded hole (17a) and to move the tool holder (10) in longitudinal directions.

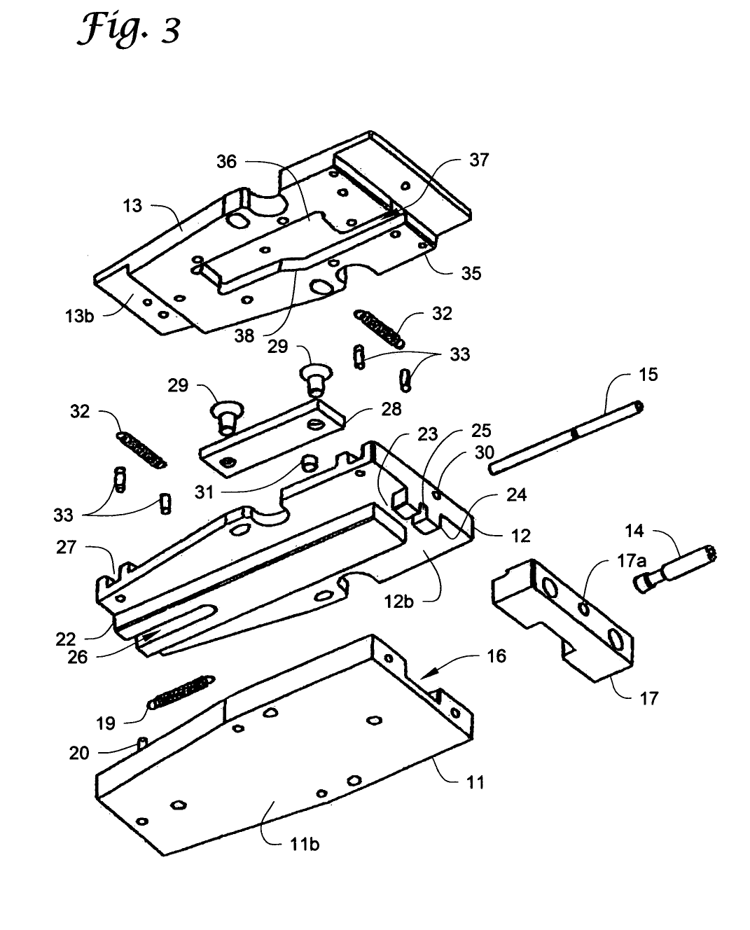

The intermediate plate (12) of the adjustable tool holder (10) having the corresponding shape with the base plate (11) with a top surface (12a) and a bottom surface (12b) as shown in FIG. 2 and 3. The bottom surface (12b) of the intermediate plate (12) is ribbed at the center to engage with the longitudinal groove (16) of the base plate (11) when both plates (11, 12) are attached together. A step (22) which is partially the length of the intermediate plate (12) is provided at the bottom surface (12b) of the intermediate plate (12). The step (22) is extended from a second end of the intermediate plate (12) and stopped at a predetermined position of the bottom surface (12b) of the intermediate plate (12) leaving a gap (23) between the end of the step (22) and a first end of the intermediate plate (12). An end block (24) which is integrally formed with the bottom surface (12b) of the intermediate plate (22) is provided at the first end of the intermediate plate (12) as shown in FIG. 3. The end block (24) includes an aperture (25) for receiving the operating rod (14) of the base plate (11). In an assembled position, when the operating rod (14) is extended into the threaded hole (17a) of the base plate (11) and the aperture (25), the tool holder (10) will be pushed inwardly and when the operating rod (14) is retracted, the base plate (11) will then pulled outwardly by the biasing means (19). A channel (26) is formed at the step (22) of the second end of the intermediate plate (12) to accommodate the biasing means (19) of the base plate (11).

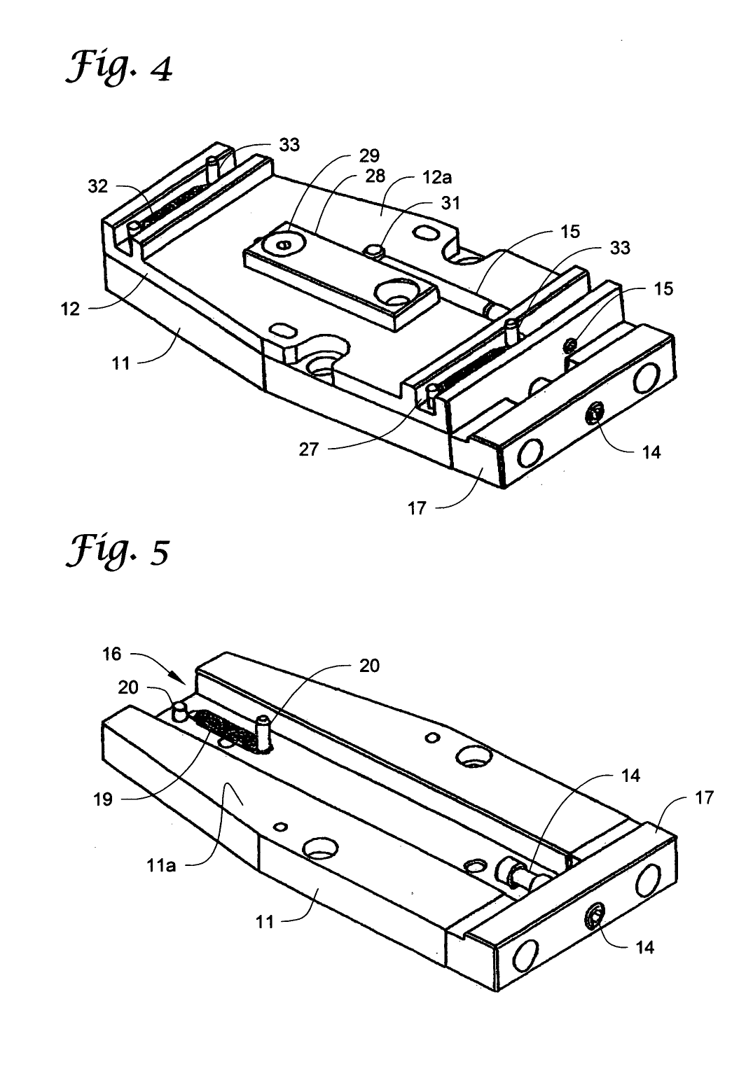

The top surface (12a) of the intermediate plate (12) has two transverse grooves (27) at the opposing ends of the intermediate plate (12) as shown in FIG. 2. A block piece (28) is mounted in longitudinal direction between the transverse grooves (27) with fasteners (29). A pair of aligned rod holes (30) is formed at one of the transverse grooves (27) at the first end of the intermediate plate (12) for receiving an elongated rod (15) extended from the outer end across the transverse groove (27) into the area in between the transverse grooves (27). The inner end of the elongated rod (15) is connected with a roller (31) which is placed adjacent the block piece (28) as shown in FIG. 4. A pair of biasing means (32) is fitted in transverse direction within the transverse grooves (27). Each of the biasing means (32) is held by a set of posts (33) which is vertically mounted at the transverse groove (27). One of the posts of each set of posts (33) is extended into an aligned hole (18) provided at the top plate (13) of the tool holder (10). The elongated rod (15) is also preferably a threaded elongated rod to enable precise movement of the elongated rod (15) into the aligned rod hole (30) and to move the tool holder in transverse directions.

The top plate (13) of the adjustable tool holder (10) also has two surfaces which are the top surface (13a) and the bottom surface (13b). The top surface (13a) is generally a flat surface where a work module to be mounted thereon. At the bottom surface (13b) of the top plate (13), a top plate step (35) is provided at the middle of the top plate (13) to be fitted into the area in between the transverse grooves (27) of the intermediate plate (12) when the top plate (13) is attached to the intermediate plate (12). A recess (36) is formed at the top plate step (35) of the top plate (13) to allow the block piece (28) to be fitted there into. A passage (37) is integrally formed with the recess (36) which is extended from the first end of the top plate step (35) and ended with an inclined surface (38) connected to the recess (36) as shown in FIG. 3. The width of the recess (36) is formed wider than the width of the block piece (28) leaving a gap there between for allowing the transverse movements of the tool holder (10). When the intermediate plate (12) and the top plate (13) are assembled together, the elongated rod (15) will be fitted within the passage (37) of the top plate (13) with the roller (31) placed at the inclined surface (38) of the recess (36).

The transverse movements of the top plate (13) of the tool holder (10) in X direction are adjustable by adjusting the elongated rod (15). In an assembled position, when the elongated rod (15) is extended into the aligned rod hole (30) of the intermediate plate (12) and through the passage (37), the elongated rod (15) will push with the roller (31) to the inclined surface (38) of the recess (36). The roller (31) is then shifted to engage and push the top plate (13) to move in the transverse directions. When the elongated rod (15) is retracted and the roller (31) moving backward on the inclined surface (38), the top plate (13) will revert to the original position by the pair of biasing means (32).

As will be readily apparent to those skilled in the art, the present invention may easily be produced in other specific forms without departing from its spirit or essential characteristics. The present embodiments is, therefore, to be considered as merely illustrative and not restrictive, the scope of the invention being indicated by the claims rather than the foregoing description, and all changes which come within therefore intended to be embraced therein.

1. An adjustable tool holder for holding a work module comprising:
a base plate having a bottom surface to be placed on a base and a top surface having a longitudinal groove thereon;
an intermediate plate having a bottom surface ribbed at the center to be fitted into said longitudinal groove on said top surface of the base plate and a top surface having transverse grooves at the opposing ends of said intermediate plate with a block piece mounted between said transverse grooves;
an elongated rod extended across one of said transverse groove of said intermediate plate with its inner end connected with a roller which is placed adjacent said block piece; and
a top plate having its bottom surface formed with a recess for receiving said block piece and said recess is formed with an inclined surface for enabling said elongated rod to engage with said roller and to move said top plate in transverse directions.

2. The adjustable tool holder as claimed in claim 1, wherein said base plate is attached with a base attachment having a threaded hole at substantially middle and extended from the side of said base attachment and a pair of through holes formed adjacent said threaded hole to be fastened to a first end of said base plate by fasteners.

3. The adjustable tool holder as claimed in claim 2, wherein said base plate further comprising an operating rod which is extended from the outer end of said base attachment into said threaded hole of said base attachment.

4. The adjustable tool holder as claimed in claim 1, wherein said longitudinal groove of said base plate is formed in the lengthwise of said base plate.

5. The adjustable tool holder as claimed in claim 1, wherein said bottom surface of the intermediate plate is formed with a step which is partially the length of said intermediate plate leaving a gap between the end of said step and a first end of said intermediate plate.

6. The adjustable tool holder as claimed in claim 5, wherein said step is formed with a channel at a second end of said intermediate plate to accommodate a biasing means attached within said longitudinal groove of the base plate.

7. The adjustable tool holder as claimed in claim 5, wherein said intermediate plate is provided with an end block integrally formed at a first end which is opposed said second end of the intermediate plate, whereby said end block having an aperture for receiving said operating rod of the base plate.

8. The adjustable tool holder as claimed in claim 7, wherein said end block is formed with a gap between said end position of said step and said end block to enable said operating rod to engage with said end position of the step for longitudinal movements of the top plate.

9. The adjustable tool holder as claimed in claim 1, wherein said top surface of the intermediate plate has two transverse grooves formed at the opposing ends of said intermediate plate leaving an area in between said transverse grooves.

10. The adjustable tool holder as claimed in claim 9, wherein said top surface of the intermediate plate further comprising a block piece mounted in longitudinal direction at said area between said transverse grooves.

11. The adjustable tool holder as claimed in claim 10, wherein said each of the transverse groove is fitted with a biasing means in transverse direction within said transverse groove for connecting said intermediate plate with said top plate.

12. The adjustable tool holder as claimed in claim 1, wherein said elongated rod is attached across said one of the transverse grooves via a pair of aligned rod holes formed thereon.

13. The adjustable tool holder as claimed in claim 1, wherein said top plate has a top surface for a work module to be placed thereon.

14. The adjustable tool holder as claimed in claim 1, wherein said bottom surface of said top plate has a top plate step to be fitted into said area between the transverse grooves of said intermediate plate.

15. The adjustable tool holder as claimed in claim 1, wherein said recess includes a passage which is extended from a first end of said top plate step and ended with an inclined surface connected to said recess.

16. The adjustable tool holder as claimed in claim 15, wherein said recess having its width wider than the width of said block piece of the intermediate plate leaving a gap there between for allowing the transverse movements of the top plate.
